(19) United States
(12) Patent Application Publication
(10) Pub. No.: US 2026/0339399 A1
(43) Pub. Date: Oct. 29, 2026

(54) WATERDROP-TYPE HINGE MODULE FOR FOLDABLE LAPTOP AND FOLDABLE LAPTOP USING THE SAME

(71) Applicant: PARTSTEC CONSTRUCTION CO., LTD, Gumi-Si, Gyeongsangbuk-Do (KR)

(72) Inventors: Young Tak Lee, Gumi-Si, Gyeongsangbuk-Do (KR); Kil Seok Jeong, Gumi-Si, Gyeongsangbuk-Do (KR)

(21) Appl. No.: 18/995,827

(22) PCT Filed: Oct. 16, 2024
(86) PCT No.: PCT/KR2024/015671

§ 371 Date: Jan. 16, 2025

(30) Foreign Application Priority Data
Nov. 30, 2023 (KR) 10-2023-0171726

(51) Int. Cl. G06F 1/16

(52) U.S. Cl. CPC G06F 1/1681

(57) ABSTRACT

The present invention relates to a waterdrop-type hinge module for a foldable portable terminal and a foldable portable terminal using the same, particularly, to a waterdrop-type hinge module for a foldable portable terminal that curbs damage to a flexible display by forming a folding part of the flexible display into a waterdrop shape when the unfolded foldable portable terminal is folded, and a foldable portable terminal using the same.

### DESCRIPTION

### Technical Field

The present invention relates to a waterdrop-type hinge module for a foldable laptop and a foldable laptop using the same, particularly, to a waterdrop-type hinge module for a foldable laptop that curbs damage to a flexible display by forming a folding part of the flexible display into a waterdrop shape when the unfolded foldable laptop is folded, and a foldable laptop using the same.

### Background Art

In general, flexible display panels are display panels that can be bent with a given curvature.

Since these flexible display panels include plastic substrates instead of the commonly used glass substrates, the flexible display panels are often manufactured using a low-temperature manufacturing process instead of the existing manufacturing processes in order to curb damage to the substrates.

These flexible display panels are manufactured as touchscreens which can receive user commands in a touch manner, for example, on which capacitive or resistive touch input can be performed.

Meanwhile, portable foldable display devices, that is, folding-type portable laptops, in the related art are equipped with a flexible display panel on which touch input can be performed as described above.

The folding-type portable laptops in the related art described above have, at a part where the hinge connection is performed between a pair of bodies supporting a flexible display panel, a given accommodating space enabling a folded part of the flexible display panel to be bent in a curved shape.

Various hinge modules are currently developed to be used for opening and closing the flexible displays described above.

However, most hinge modules have a complex structure, a large number of components, and a significant thickness at a folding part, and have a risk of damage due to infiltration of foreign matter into and impact on a large gap produced at a part of the flexible display that is folded and facing when the flexible display is folded.

In particular, a folding central part of the flexible display needs to form a waterdrop shape having a narrow top and a wide bottom in order to prevent damage and concentration of a load when being folded. However, the hinge modules in the related art have limitations in perfectly implementing this shape.

### SUMMARY OF INVENTION

### Technical Problem

The present invention is made to solve the above-described problems, and an object thereof is to provide a waterdrop-type hinge module for a foldable laptop that enables a folding center of a flexible display to be folded while stably forming a waterdrop shape when the foldable laptop is folded by using a relatively simple structure and a small number of components, and a foldable laptop using the waterdrop-type hinge module.

### Solution to Problem

In order to achieve the object, there is provided a waterdrop-type hinge module for a foldable laptop, including: a base body; a pair of swing bars that are disposed on both sides of the base body, each having one end coupled to the base body to be rotatable in a vertical direction; swing plates that are fixedly coupled to the other ends of the swing bars and deform a flexible display of the laptop; slide levers having one ends coupled to the base body to be rotatable in the vertical direction; a synchronization member that connects a pair of the slide levers separated from each other to synchronize rotational motion of the pair of slide levers; and slide blocks that have respective upper ends which are rotatably hinge-coupled to the swing plates and have slide blocks to which the slide levers are slidably coupled therein. When the laptop is closed, one of the swing bars and one of the swing plates are rotated together at the same angle beyond 90 degrees from a horizontal state, the slide blocks are pulled out from the slide levers and slide while being rotated together with the swing plates, and the slide levers are rotated with respect to the base body by the rotation of the slide blocks, the slide blocks are rotated less than the swing plates to which the slide blocks are hinge-coupled, and the slide levers and slide blocks are rotated at an angle smaller than that of the swing bars and the swing plates. The swing plates form a folding part of a flexible display of the laptop into a waterdrop shape having a narrow top and a wide bottom when the laptop is closed.

The waterdrop-type hinge module for a foldable laptop further includes a first leaf spring that is in contact with outer circumferential surfaces of one ends of the pair of swing bars that are separated from each other. The outer circumferential surfaces of the one ends of the swing bars have an arc shape and have a first insertion groove and a second insertion groove that are separated from each other, and both ends of the first leaf spring have semi-cylindrical cam protrusions, respectively. When one of the cam protrusions is disposed adjacent to the first insertion groove or the second insertion groove due to the rotation of the swing bars, the cam protrusion is inserted into the first insertion groove or the second insertion groove by elastic force of the cam protrusion and applies torque to further rotate the swing bars.

On one ends of the slide levers, circular column-shaped first shafts are formed to be rotatably mounted on the base body. The waterdrop-type hinge module further includes a second leaf spring that is in contact with outer circumferential surfaces of a pair of the first shafts which are separated from each other. Each of the outer circumferential surfaces of the first shafts is chamfered to form a first stop surface and a second stop surface. An arc-shaped shaft curve part that is in contact with the second leaf spring is formed between the first stop surface and the second stop surface which are separated from each other, and the first stop surface and the second stop surface are disposed to form an angle smaller than 90 degrees. When the laptop is unfolded in a horizontal direction, the first stop surface and the second leaf spring are disposed to face each other in a separated state from each other, and the second leaf spring applies torque to the slide levers in a rotational direction in which the laptop is unfolded. When the laptop is folded, the second stop surface and the second leaf spring are disposed to face each other in a separated state from each other, and the second leaf spring applies torque to the slide levers in a rotational direction in which the laptop is folded.

The waterdrop-type hinge module further includes a third leaf spring that connects the first shafts that are separated from each other. Both ends of the third leaf spring generate friction with the outer circumferential surfaces of the first shafts by wrapping around the outer circumferential surfaces of the first shafts disposed on both sides so that a state in which the slide levers are rotated at a certain angle is maintained as is due to the friction.

In addition, in order to achieve the object, there is provided a foldable laptop of the present invention including: a first body; a second body; a hinge module connecting the first body and the second body, and a flexible display, and the hinge module is configured of the hinge module described above. The first body and the second body are fixedly coupled to the respective slide blocks on both sides, the slide blocks constituting the hinge module.

### Advantageous Effects of Invention

According to the waterdrop-type hinge module for a foldable laptop and the foldable laptop using the same of the present invention as described above, the following effects will be achieved.

According to the present invention, the folding center of the flexible display can be folded while stably forming a waterdrop shape when the foldable laptop is folded.

In particular, the folding center of the flexible display perfectly forms the waterdrop shape so that it is possible to prevent the flexible display from being damaged or subjected to a heavy load while being folded, and it is possible to improve durability.

In addition, a structure of the hinge module is relatively simple and includes a small number of components, and it is possible to improve productivity, assemblability, and workability.

### BRIEF DESCRIPTION OF DRAWINGS

FIG. 1 is a perspective view in one direction illustrating a state in which a hinge module for a foldable laptop is unfolded according to an embodiment of the present invention.

FIG. 2 is a perspective view in the other direction illustrating the state in which the hinge module for a foldable laptop is unfolded according to the embodiment of the present invention.

FIG. 3 is an exploded perspective view in the one direction illustrating the hinge module for a foldable laptop according to the embodiment of the present invention.

FIG. 4 is a perspective view illustrating a state in which an upper body of a base body is removed from FIG. 1.

FIG. 5 is an assembled view of swing bars and a first leaf spring according to the embodiment of the present invention.

FIG. 6 is an assembled view of slide levers and a second leaf spring according to the embodiment of the present invention.

FIG. 7 is a cross-sectional perspective view of the slide levers in FIG. 6.

FIG. 8 is a perspective view illustrating a state in which the slide levers are rotated by 45 degrees according to the embodiment of the present invention.

FIG. 9 is a perspective view illustrating a state in which the hinge module for a foldable laptop is rotated by about 45 degrees according to the embodiment of the present invention.

FIG. 10 is a perspective view illustrating a state in which the hinge module for a foldable laptop is closed according to the embodiment of the present invention.

FIG. 11 is a side view depicting a process of unfolding the hinge module for a foldable laptop according to the embodiment of the present invention.

FIG. 12 is an exploded perspective view of a laptop on which the hinge module is mounted according to the embodiment of the present invention.

FIG. 13 is a cross-sectional structure view of the laptop on which the hinge module is mounted according to the embodiment of the present invention.

### DESCRIPTION OF EMBODIMENTS

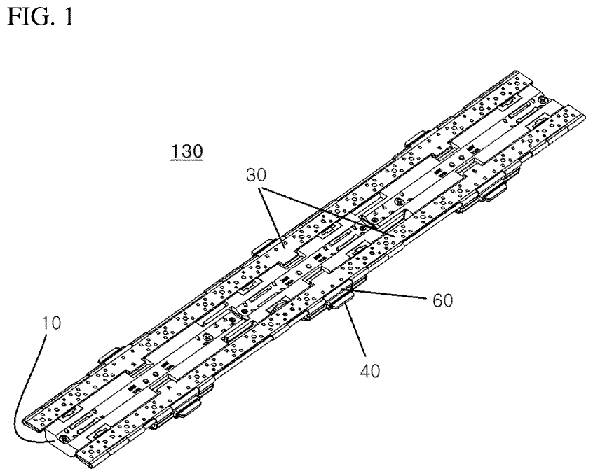

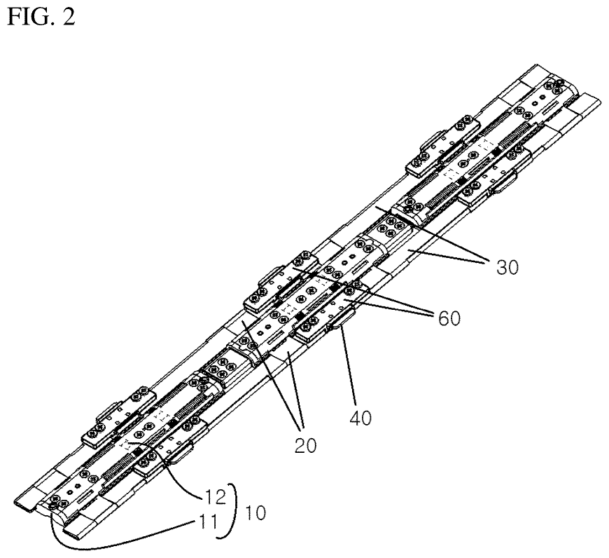

A waterdrop-type hinge module 130 for a foldable laptop of the present invention includes, as shown in FIGS. 1 to 4, a base body 10, a swing bar 20, a swing plate 30, a slide lever 40, a synchronization member 50, a slide block 60, and the like.

The base body 10 is formed in a long bar shape.

In this embodiment, the base body 10 includes an upper body 11 and a lower body 12 which are layered on each other to be coupled.

In a case where the base body 10 has a long length, it is preferable to manufacture the base body 10 by dividing the base body into several base bodies as shown in the drawings of this embodiment and then couple the bodies to each other.

The swing bars 20 form a pair and are disposed to be separated from each other on both sides of the base body 10.

One ends of the swing bars 20 are coupled to the base body 10 to be rotatable in a vertical direction.

Specifically, the one ends of the swing bars 20 are inserted and disposed between the upper body 11 and the lower body 12.

The swing plates 30 are fixedly coupled to the other ends of the swing bars 20 and are rotated together with the swing bars 20 when the swing bars are rotated.

On upper surfaces of the swing plates 30, a flexible display 140 of the laptop is disposed.

These swing plates 30 deform a folding part of the flexible display 140 of the laptop into a waterdrop shape having a narrow top and a wide bottom when the laptop is closed.

The slide levers 40 form a pair and are disposed to be separated from each other on both sides of the base body 10.

One ends of these slide levers 40 are coupled to the base body 10 to be rotatable in the vertical direction.

Specifically, the one ends of the slide levers 40 are inserted and disposed between the upper body 11 and the lower body 12.

The synchronization member 50 connects a pair of the slide levers 40 separated from each other to synchronize rotational motion of the pair of slide levers.

Specifically, on the one ends of the slide lever 40, as shown in FIGS. 4 and 6 to 8, circular column-shaped first shafts 41 formed to be rotatably mounted on the base body 10 are formed.

On outer circumferential surfaces of the first shafts 41, respective first gears 42 are formed.

The synchronization member 50 is formed of a second gear that connects the first gears 42 formed on the first shafts 41.

Such a structure causes the pair of swing bars 20 to be rotated in a direction in which the swing bars come closer to each other or move away from each other, as one of the swing bars 20 is rotated and then the other swing bar 20 is also synchronized to rotate by the first gears 42 and the synchronization member 50.

The slide blocks 60 have respective upper ends which are rotatably hinge-coupled to the swing plates 30 and have slide blocks to which the slide levers 40 are slidably coupled therein.

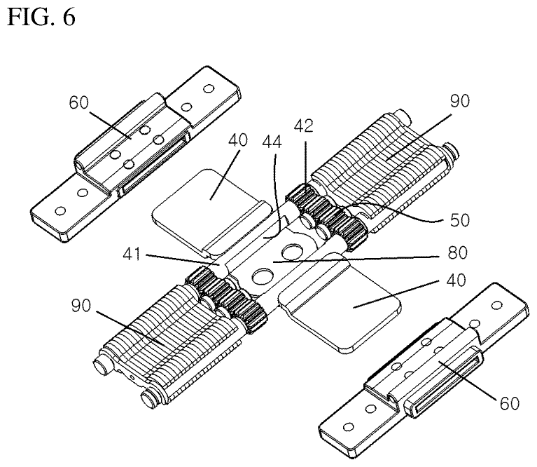

FIG. 6 clearly illustrates a structure in which the slide blocks 60 are slidably mounted on the slide levers 40.

A first rotation center point of one end of the swing bar 20 is located above a second rotation center point of one end of the slide lever 40.

Further, the second rotation center point of the one end of the slide lever 40 is located farther away from a central part of the base body 10 than the first rotation center point of the one end of the swing bar 20 is.

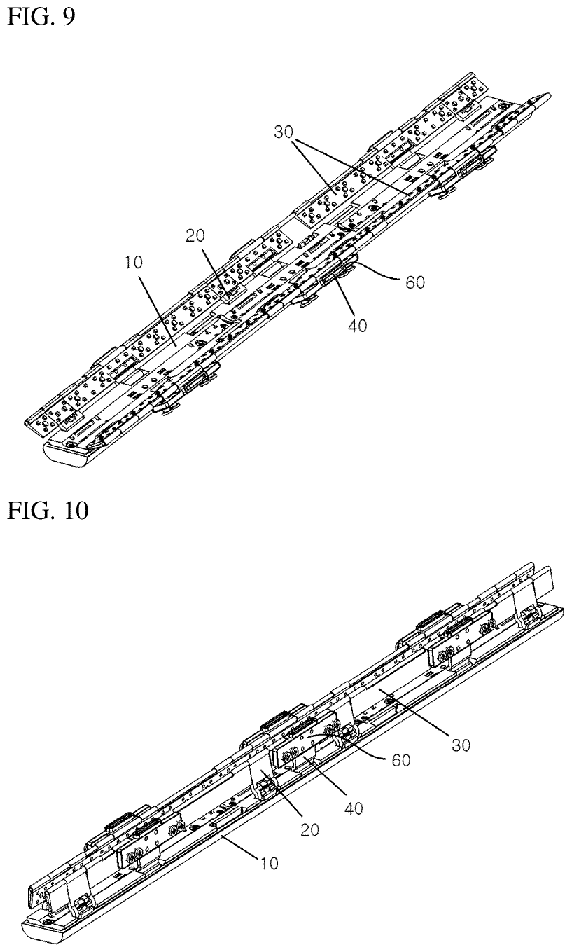

According to the configuration and the structure as described above, when the hinge module 130 and the laptop are closed from an unfolded state of the hinge module 130, that is, when the swing plates 30 on both sides are rotated and moved closer to each other, as shown in FIGS. 8 to 10, one of the swing bars 20 and one of the swing plates 30 are rotated together at the same angle beyond 90 degrees from a horizontal state.

Further, the slide blocks 60 hinge-coupled to the swing plates 30 are pulled out from the slide levers 40 and slide while being rotated together with the swing plates 30, and the slide levers 40 are rotated with respect to the base body 10 by the rotation of the slide blocks 60.

In this case, the slide blocks 60 are rotated less than the swing plates 30 to which the slide blocks are hinge-coupled.

The slide levers 40 and slide blocks 60 are rotated at an angle smaller than that of the swing bars 20 and the swing plates 30.

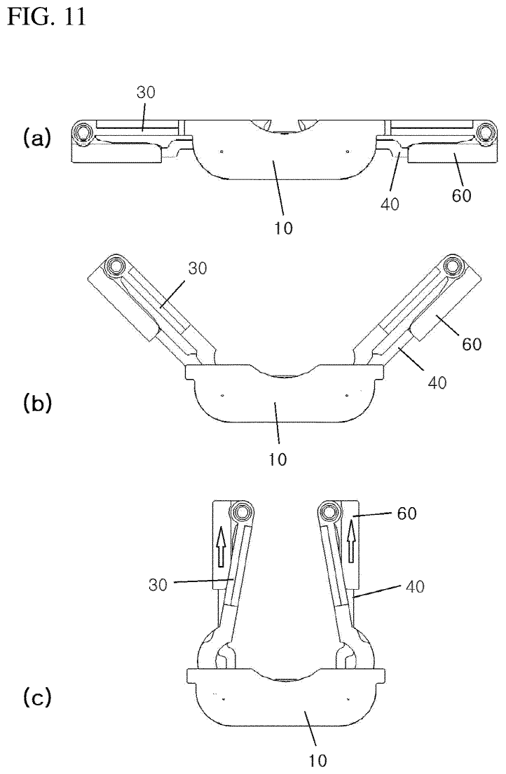

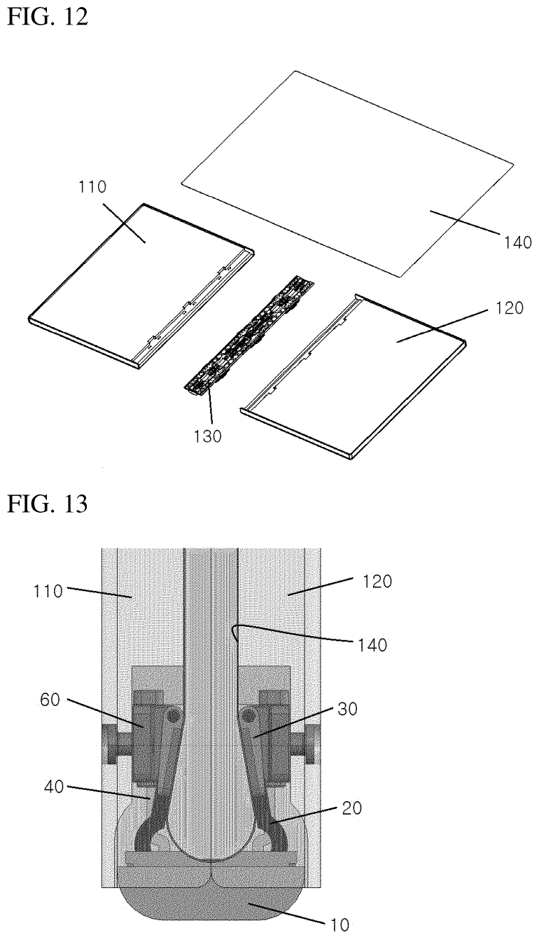

That is, as shown in FIG. 11, when the laptop is closed, one of the swing bars 20 and one of the swing plates 30 are rotated beyond 90 degrees from the horizontal state. While the rotating slide levers 40 are in contact with respective stop bumps formed on the base body 10 and stop rotating, the slide levers 40 and the slide blocks 60 are rotated at an angle smaller than that of the swing bars 20 and the swing plates 30.

Preferably, when the laptop is closed from an unfolded state, the swing bars 20 and the swing plates 30 are to be rotated by 100 degrees, and the slide levers 40 and the slide blocks 60 are to be rotated by 90 degrees.

According to the configurations and the operations described above, as shown in FIG. 13, the swing plates 30 enable the folding part of the flexible display 140 of the laptop to be formed into a waterdrop shape having a narrow top and a wide bottom when the laptop is closed.

The present invention may further include a first leaf spring 70, a second leaf spring 80, a third leaf spring 90, and the like.

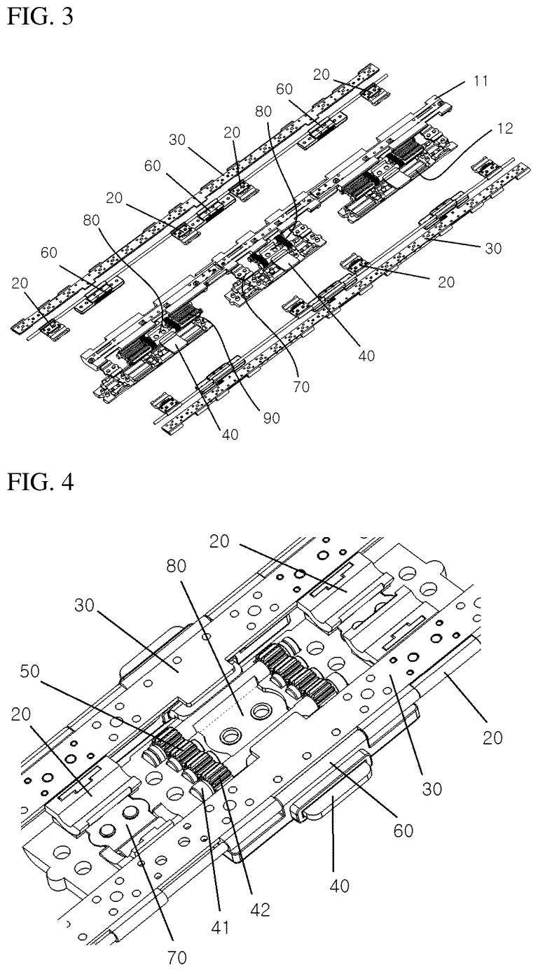

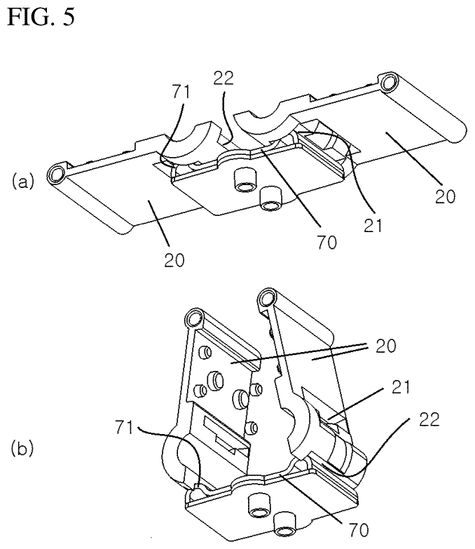

The first leaf spring 70 is mounted on the base body 10 as shown in FIGS. 3 and 5, and is in contact with outer circumferential surfaces of one ends of the pair of swing bars 20 which are separated from each other.

That is, both ends of the first leaf spring 70 are in contact with the respective one ends of the pair of swing bars 20, the swing bars being disposed to be separated from each other.

The outer circumferential surfaces of the one ends of the swing bars 20 have an arc shape and have a first insertion groove 21 and a second insertion groove 22 that are separated from each other.

Further, both ends of the first leaf spring 70 have semi-cylindrical cam protrusions 71, respectively.

When one of the cam protrusions 71 is disposed adjacent to the first insertion groove 21 or the second insertion groove 22 due to the rotation of the swing bars 20, the cam protrusion 71 is inserted into the first insertion groove 21 or the second insertion groove 22 by elastic force of the cam protrusion 71 and applies torque to further rotate the swing bars 20.

More specifically, the cam protrusion 71 is inserted into the first insertion groove 21 when the laptop is unfolded in the horizontal direction, and the cam protrusion 71 is inserted into the second insertion groove 22 when the laptop is folded and closed.

According to the configuration described above, when the cam protrusion 71 is disposed adjacent to the first insertion groove 21, the cam protrusion 71 is inserted into the first insertion groove 21 by the elastic force of the first leaf spring 70, rotates the swing bars 20, and applies torque in a direction in which the laptop is opened.

In addition, when the cam protrusion 71 is disposed adjacent to the second insertion groove 22, the cam protrusion 71 is inserted into the second insertion groove 22 by the elastic force of the first leaf spring 70, rotates the swing bars 20, and applies torque in a direction in which the laptop is closed.

As a result, the laptop can be unfolded or closed more quickly and firmly due to a pre-load applied by the first leaf spring 70 in an unfolding or closing process.

The second leaf spring 80 is disposed below the first shaft 41 formed at the one ends of the pair of slide levers 40 that are separated from each other, as shown in FIGS. 3, 4, and 6 to 8.

The second leaf spring 80 is in contact with the outer circumferential surfaces of the first shafts 41.

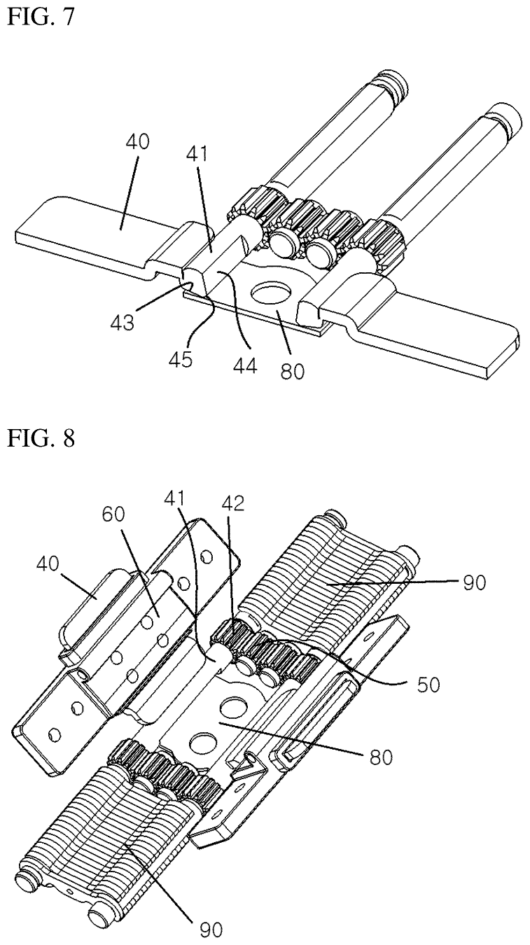

As shown in FIG. 7, each of the outer circumferential surfaces of the first shafts 41 is chamfered to form a first stop surface 43 and a second stop surface 44.

An arc-shaped shaft curve part 45 which is in contact with the second leaf spring 80 is formed between the first stop surface 43 and the second stop surface 44 which are separated from each other.

Further, the first stop surface 43 and the second stop surface 44 are disposed to form an angle smaller than 90 degrees.

When the laptop is unfolded in the horizontal direction, the first stop surface 43 and the second leaf spring 80 are disposed to face each other in a separated state from each other, and the second leaf spring 80 applies torque to the slide levers 40 in a rotational direction in which the laptop is unfolded.

Further, when the laptop is folded, the second stop surface 44 and the second leaf spring 80 are disposed to face each other in a separated state from each other, and the second leaf spring 80 applies torque to the slide levers 40 in a rotational direction in which the laptop is folded.

As a result, the laptop can be unfolded or closed more quickly and firmly due to a pre-load applied by the second leaf spring 80 in the unfolding or closing process.

The third leaf spring 90 connects the first shafts 41 separated from each other as shown in FIGS. 3, 6, and 8.

Both ends of the third spring 90 are mounted to generate friction with the outer circumferential surfaces of the first shafts 41 while wrapping around the outer circumferential surfaces of the first shafts 41 disposed on both sides.

It is possible to easily implement a free stop function that allows a state in which the slide levers 40 are rotated at a certain angle when the first shafts 41 are rotated to be maintained as is due to the friction between both ends of the third leaf spring 90 and the outer circumferential surfaces of the first shafts 41.

Meanwhile, the foldable laptop of the present invention includes a first body 110, a second body 120, the hinge module 130 connecting the first body 110 and the second body 120, and the flexible display 140, as shown in FIGS. 11 and 13.

The hinge module 130 is configured of the hinge module of the present invention described above.

The first body 110 and the second body 120 are fixedly coupled to the respective slide blocks 60 on both sides, the slide blocks constituting the hinge module 130.

While the first body 110 and the second body 120 are rotated in opposite directions and the laptop is unfolded, the flexible display 140 is unfolded to be flat.

In this state, when the first body 110 and the second body 120 are rotated in a direction in which the bodies come closer and the laptop is closed, as described above, the swing bars 20 and the swing plates 30 are rotated by 100 degrees, and the slide levers 40 and the slide blocks 60 are rotated by 90 degrees. Hence, the first body 110 and the second body 120 coupled to the slide blocks 60 are also rotated by 90 degrees.

As a result, as shown in FIG. 13, the swing plates 30 are rotated to form the central part, that is, the folding part, of the flexible display 140 into the waterdrop shape having a narrow top and a wide bottom.

The present invention can be applied to a notebook computer, a laptop computer, a tablet PC, and the like.

The waterdrop-type hinge module for a foldable laptop and a foldable laptop using the same that are the present invention are not limited to the embodiments described above and can be variously modified within the scope of the technical idea of the present invention.

### INDUSTRIAL APPLICABILITY

The present invention can be applied to a hinge module for a foldable laptop and a foldable laptop, thus having industrial applicability.

1. A waterdrop-type hinge module for a foldable laptop, comprising: a base body;
a pair of swing bars that are disposed on both sides of the base body, each having one end coupled to the base body to be rotatable in a vertical direction;
swing plates that are fixedly coupled to the other ends of the swing bars and deform a flexible display of the laptop;
slide levers having one ends coupled to the base body to be rotatable in the vertical direction;
a synchronization member that connects a pair of the slide levers separated from each other to synchronize rotational motion of the pair of slide levers; and
slide blocks that have respective upper ends which are rotatably hinge-coupled to the swing plates and have slide blocks to which the slide levers are slidably coupled therein.
wherein, when the laptop is closed,
one of the swing bars and one of the swing plates are rotated together at the same angle beyond 90 degrees from a horizontal state,
the slide blocks are pulled out from the slide levers and slide while being rotated together with the swing plates, and the slide levers are rotated with respect to the base body by the rotation of the slide blocks,
the slide levers and slide blocks are rotated at an angle smaller than that of the swing bars and the swing plates, and
the swing plates form a folding part of a flexible display of the laptop into a waterdrop shape having a narrow top and a wide bottom when the laptop is closed.

2. The waterdrop-type hinge module for a foldable laptop according to claim 1, further comprising
a first leaf spring that is in contact with outer circumferential surfaces of one ends of the pair of swing bars that are separated from each other,
wherein the outer circumferential surfaces of the one ends of the swing bars have an arc shape and have a first insertion groove and a second insertion groove that are separated from each other,
both ends of the first leaf spring have semi-cylindrical cam protrusions, respectively, and
when one of the cam protrusions is disposed adjacent to the first insertion groove or the second insertion groove due to the rotation of the swing bars, the cam protrusion is inserted into the first insertion groove or the second insertion groove by elastic force of the cam protrusion and applies torque to further rotate the swing bars.

3. The waterdrop-type hinge module for a foldable laptop according to claim 1,
wherein, on one ends of the slide levers, circular column-shaped first shafts are formed to be rotatably mounted on the base body,
the waterdrop-type hinge module further comprises a second leaf spring that is in contact with outer circumferential surfaces of a pair of the first shafts which are separated from each other,
each of the outer circumferential surfaces of the first shafts is chamfered to form a first stop surface and a second stop surface,
an arc-shaped shaft curve part that is in contact with the second leaf spring is formed between the first stop surface and the second stop surface which are separated from each other,
the first stop surface and the second stop surface are disposed to form an angle smaller than 90 degrees,
when the laptop is unfolded in a horizontal direction, the first stop surface and the second leaf spring are disposed to face each other in a separated state from each other, and the second leaf spring applies torque to the slide levers in a rotational direction in which the laptop is unfolded, and
when the laptop is folded, the second stop surface and the second leaf spring are disposed to face each other in a separated state from each other, and the second leaf spring applies torque to the slide levers in a rotational direction in which the laptop is folded.

4. The waterdrop-type hinge module for a foldable laptop according to claim 3, further comprising
a third leaf spring that connects the first shafts that are separated from each other,
wherein both ends of the third leaf spring generate friction with the outer circumferential surfaces of the first shafts by wrapping around the outer circumferential surfaces of the first shafts disposed on both sides so that a state in which the slide levers are rotated at a certain angle is maintained as is due to the friction.

5. A foldable laptop comprising: a first body; a second body; a hinge module connecting the first body and the second body, and a flexible display,
wherein the hinge module is configured of the hinge module according to claim 1, and
the first body and the second body are fixedly coupled to the respective slide blocks on both sides, the slide blocks constituting the hinge module.
